(19) United States
(12) Patent Application Publication
(10) Pub. No.: US 2011/0262703 A1
(43) Pub. Date: Oct. 27, 2011

(54) PROCESS FOR PRODUCING A COMPOSITE COMPONENT FROM PLASTIC, COMPOSITE COMPONENT PRODUCED BY THIS PROCESS AND USE OF SUCH A COMPONENT

(75) Inventors: Dirk Legler, Weil (DE); Jan Woköck, Bad Aibling (DE); Adam Wagner, Germering (DE); Thomas Peter, Ambach (DE); Michael Kölbl, Neuried (DE); Thomas Stemmer, Munich (DE); Petra Heuser, Munich (DE); Detlef Mies, Elsdorf (DE); Hans-Jürgen Liebig, Leverkusen (DE)

(73) Assignees: BAYER MATERIALSCIENCE AG, Leverkusen (DE); WEBASTO AG, Stockdorf (DE)

(21) Appl. No.: 13/002,633

(22) PCT Filed: Jul. 2, 2009
(86) PCT No.: PCT/EP2009/004794

§ 371 Date: Feb. 18, 2011

(30) Foreign Application Priority Data
Aug. 1, 2008 (DE) 10 2008 035 918.1

(51) Int. Cl. B32B 3/00; B29C 70/08

(52) U.S. Cl. 428/156; 156/182

(57) ABSTRACT

The invention relates to a process for producing a composite component, with the following steps: separate producing a decorative composite made of at least one backing layer and of at least one colorant layer, separate producing a structural composite made of at least one outer layer and of at least one spacer confected thereto, introducing a connecting layer between decorative composite and structural composite, and joining of the structural composite and of the decorative composite together with hardening of the connecting layer.

### CROSS-REFERENCE TO RELATED APPLICATIONS

This application is a U.S. national phase application filed under 35 U.S.C. §371 of International Application No. PCT/EP2009/004794, filed Jul. 2, 2009, designating the United States, which claims priority from Germany Patent Application No.: DE 10 2008 035 918.1, filed Aug. 1, 2008, which are hereby incorporated herein by reference in their entirety for all purposes.

### BACKGROUND OF THE INVENTION

The invention relates to a process for producing a composite component made of plastic as claimed in claim 1, a composite component as claimed in claim 13 produced by said process, and an advantageous use, as claimed in claim 15, of this type of composite component.

DE 102 44 287 A1 discloses a composite component for a vehicle, which is composed of an exterior skin made of a foil and of a reinforcing backing layer, which is composed of a honeycomb structure and respectively of a polyurethane layer which covers this on the two sides and has reinforcing glass fibers. The composite component is produced in a mold in a plurality of steps. By virtue of the hardening times needed for the individual layers, the composite component requires a relatively long total cycle time, and for relatively large numbers of units it is therefore necessary to use a plurality of parallel manufacturing lines using relatively expensive molds.

### BRIEF SUMMARY OF THE INVENTION

The invention is based on the object of providing a process for producing a composite component made of plastic, and a composite component produced by said process, where production of the same can be simplified and manufacturing-process time for the same can be substantially reduced.

The invention achieves said object via the features of claim 1 in relation to the process and via the features of claim 14 in relation to the composite component. Advantageous embodiments of the invention are given in the dependent claims. One advantageous use of a composite component produced in the invention is given in claim 15.

The essence of the invention provides that the composite component is provided by joining, by means of a connecting layer, two separately produced modules, namely a decorative composite which comprises a colorant layer and which forms the exterior skin, and a structural composite which increases stability. By virtue of the separate production of the decorative composite and of the structural composite, manufacturing steps can be carried out in parallel in partial manufacturing lines or completely off-line at separate locations. When the parts are joined, it is then merely necessary to introduce the connecting layer, the hardening of which takes place much more rapidly than in the prior art. The separate production method also permits, for example, the joining of different decorative composites with different structural composites so that, by way of example, a vehicle manufacturer can use a modular method to join different colors and materials for an exterior skin with inner cladding arranged thereon, individually in accordance with customer requirements.

In one advantageous embodiment, the backing layer of the decorative composite is composed of metal, such as aluminum or steel, or of thermoplastics or of thermosets.

In another advantageous embodiment, the colorant layer is composed of one or more of the following layers: a paint and/or a primer and/or a foil and/or a layer of material. The selection and optional connection of the different materials provides great design freedom of color, structure, and appearance of the exterior skin.

The connecting layer for connecting the decorative composite to the structural composite is preferably formed from a foaming or nonfoaming polymer.

The spacer of the structural layer is preferably composed of a paper honeycomb, of a polymer foam, such as expanded polystyrene (EPS), of expanded polypropylene (EPP) or expanded polycarbonate (EPC), of melamine, of a metal foam, such as foamed aluminum, of a naturally occurring raw material, or of a monolytic structure, such as sheetmetal, glassfiber-reinforced polyurethane (PU-GF), glassfiber-reinforced epoxy (EP-GF), or glassfiber-reinforced polycarbonate (PC-GF).

The at least one outer layer of the structural layer is preferably formed from a fiber layer which is made of glass fiber, of glassfiber-reinforced polyurethane (PU-GF), of natural fibers, of polymer fibers, of inorganic fibers, of metallic fibers, or of carbon fibers and which has been embedded into a plastics matrix made of polyamide (PA), polypropylene (PP), epoxy (EP), or polyurethane (PU).

In one particularly preferred embodiment, the arrangement of the structural composite has two outer layers on the two sides of the spacer, where at least one outer layer and particularly preferably both outer layers has/have been connected both an adhesive penetrating into cavities of the spacer or with a liquid plastic. This type of structural composite has particularly high stability with very low weight.

It is further preferable that at least one shatterproofing layer has been integrated into the decorative composite and/or into the structural composite. Integration of a shatterproofing layer has been described in the German patent application DE 10 2008 033 923.7 which derives from the same applicant and the priority date of which is earlier than that of the present application, and the disclosure of which is hereby incorporated into the present application.

Particular preference is given to a process in which the production of the decorative composite and the introduction of the connecting layer take place in succession in a first mold, while the production of the structural composite takes place at a spatial distance from the location of the other steps, so that the finished structural composite can be inserted as intermediate product into a second mold and the two molds are compressed after introduction of a connecting layer between decorative composite and structural composite, in order to join the composite component.

A composite component produced by the process described above in the invention is particularly preferably used for a vehicle-exterior-skin component, such as vehicle-roof module, vehicle door, wheel surround, engine-compartment lid, trunk lid, tailgate module, roof shell of a folding cabriolet cover, front spoiler or rear spoiler. The high surface quality of the decorative composite and the increased stability due to the structural composite, in conjunction with the flexibility of coloring and of structure and with the short cycle times make the process of the invention suitable for use for producing exterior-skin components of vehicles.

In another advantageous embodiment, at least one of the layers of the decorative composite and/or the structural composite has been produced by the composite spray molding process (CSM process) and/or by the long fiber injection process (LFI process) and/or by the glassfiber-mat polyurethane process (GM-PU process) and/or by the resin transfer molding process (RTM process) and/or by the sheet molding compound process (SMC process) and/or by the reactive injection molding process (RIM process) and/or by the reinforced reactive injection molding process (RRIM process) and/or by the injection molding process.

The at least one shatterproofing layer has a shatterproofing textile which is preferably composed of polyethylene (PE) and/or of polyethylene terephthalate (PET), and/or of polyamide (PA), and/or of polypropylene (PP), and/or of aramid, and/or of elastic polyurethane (PU), and/or of natural or synthetic rubber, and/or of a steel textile.

It is likewise advantageous if the exterior skin which is the outermost part of the composite component is composed of a plastics layer which is colored in the desired vehicle color before it leaves the supplier. There is then no requirement at all for the vehicle producer to undertake any subsequent painting operations, when the composite component is used as vehicle-exterior-skin component.

The composite component of the invention is explained in more detail below by using one embodiment with reference to the drawing.

### BRIEF DESCRIPTION OF THE DRAWINGS

FIG. 1 is a diagram of the modular structure of the composite component made of decorative composite, connecting layer, and structural composite;

FIG. 2 is a diagram of the separate production of the decorative composite in a first mold and of the structural composite separately therefrom;

FIG. 3 is a diagram of the introduction of the connecting layer on to the inner side of the decorative composite in the first mold; and

FIG. 4 is a diagram of the joining of the decorative composite to the structural composite via compression of the two molds.

### DETAILED DESCRIPTION OF THE INVENTION

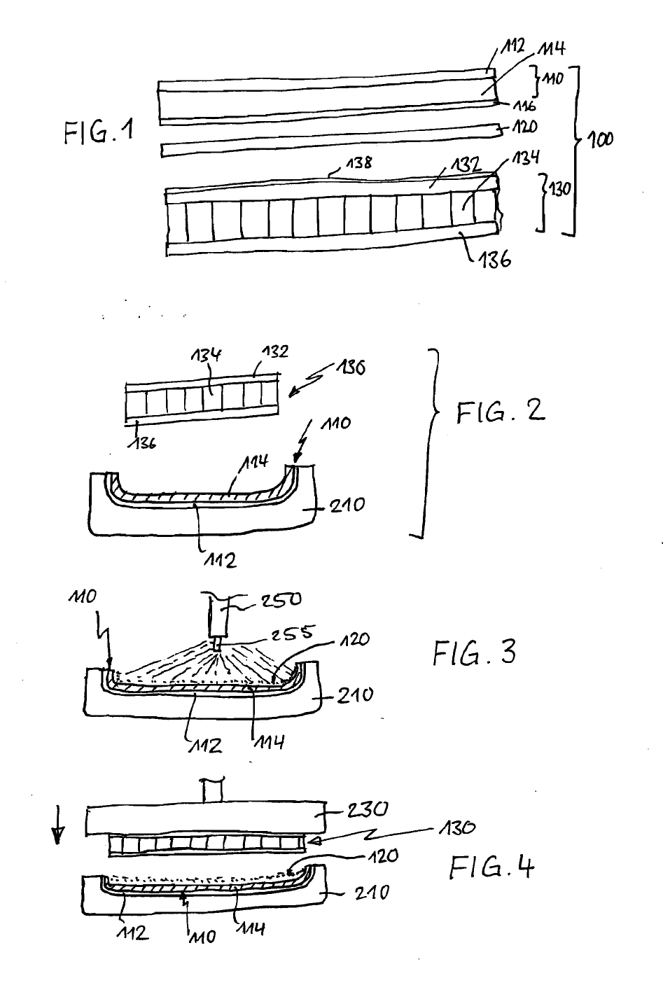

The composite component 100 shown in the diagram of FIG. 1 is of modular composition, made of a decorative composite 110 depicted in the upper portion, of a connecting layer 120, and of a structural composite 130 depicted in the lower portion.

The decorative composite 110 is composed of at least one backing layer 114 and of at least one colorant layer 112. The colorant layer 112 subsequently forms, once the composite component 100 has been joined, that layer of the same that faces outward. Optionally provided on the underside of the backing layer 114 or embedded into the same there is a shatterproofing layer 116. The backing layer 114 of the decorative composite 110 is optionally composed of metal, such as aluminum or steel sheet, or of thermoplastics or of thermosets, for example in the form of a thermoformed plastics foil. The colorant layer 112 is composed of a paint and/or of a primer and/or of a foil and/or of a layer material, the coloring of which has been matched to the desired color of the composite component. The shatterproofing layer 116 is preferably composed of a textile, which in particular has been produced from polyethylene (PE), polyethylene terephthalate (PET), polyamide (PA), polypropylene (PP), aramid, of elastic polyurethane (PU), of natural or synthetic rubber, or of a steel textile. A shatterproofing layer 116 in the form of a shatterproofing textile can also particularly preferably have been embedded into the backing layer 114, in particular if this is composed of plastic.

The connecting layer 120 is preferably composed of a foaming or nonfoaming polymer, in particular of polyurethane foam (PU). The thickness of the connecting layer 120 is preferably about 2 to 2.5 mm. This layer preferably simultaneously serves for effective prevention of an effect which is visible on the exterior skin in the colorant layer 112 and is caused by pressure transmitted from the honeycomb structure of the spacer 134, this being the type of effect that can otherwise occur during compression in a mold in the absence of a decoupling layer. Insofar as no honeycomb structure is used as spacer layer 134, but a plastic, plastics foam, metal or metal foam is used instead, the thickness of the connecting layer 120 can also be markedly smaller, since its function is then restricted to the connection of the decorative composite 110 to the structural composite 130.

The structural composite 130 is composed of an upper outer layer 132, of a spacer 134, and of a lower outer layer 136. There is optionally a shatterproofing layer 138 arranged above the upper outer layer 132, which is similar in terms of its structure to the shatterproofing layer 116. The shatterproofing textile of the shatterproofing layer 116 has in turn preferably been embedded into the plastics material of the outer layer 132. If an accident causes fracture of a composite component used as vehicle-exterior-skin component, the two shatterproofing layers 116 and, respectively, 138 ensure that fracture of the adjacent backing layers 114 and, respectively, 132, 136 does not produce any sharp edges either on the outside or on the inside.

The spacer 134 of the structural layer 130 is preferably composed of a paper honeycomb, the fillets of which have been oriented in the main direction of loading of the composite component 100, vertically with respect to the adjacent outer layers 132, 136. As an alternative, the spacer 134 can also be composed of a polyurethane foam, of a polymer foam, such as expanded polystyrene (EPS), of expanded polypropylene (EPP) or expanded polycarbonate (EPC), of melamine, of a metal foam, such as foamed aluminum, of a naturally occurring raw material, or of a monolytic structure, such as sheetmetal, glassfiber-reinforced polyurethane (PU-GF), glassfiber-reinforced epoxy (EP-GF), or glassfiber-reinforced polycarbonate (PC-GF). The spacer 134 is particularly preferably composed of a paper honeycomb, for example with thickness of about 13 mm, where the weight per unit area of the corrugated element and outer element of the honeycomb structure is respectively about 115 g per square meter and the corrugated elements have preferably been designed with A-type corrugation.

The at least one outer layer 132, 136 of the structural layer 130 is composed of a fiber layer, for example made of glass fibers, glassfiber-reinforced polyurethane (PU-GF), of natural fibers, of polymer fibers, of inorganic fibers, of metallic fibers, or of carbon fibers which has been embedded into a plastics matrix made, for example, of polyamide (PA), polypropylene (PP), epoxy (EP), or polyurethane (PU). The outer layers 132 and 136 are particularly preferably composed of polyurethane (PU) with a weight per unit area of about 300 g per square meter, which optionally and preferably has respectively been reinforced by means of a glassfiber mat with a weight per unit area of about 225 g per square meter.

It is particularly preferable that given an open-cell structure of the spacer 134, for example in the form of a honeycomb structure, the connection to the outer layers 132, 136 is strengthened via an adhesive or liquid plastic, which penetrates into the cavities of the spacer 134 and accumulates in the region of the edges of the vertical fillets.

The layer structure described hitherto made of spacer 134 and of the two adjacent outer layers 132 and 136 is preferably produced by means of the composite spray molding process (CSM process; disclosed by the company Hennecke GmbH, D-53754 Sankt Augustin) in a mold (CSM mold). It has been described in similar form previously in DE 100 33 232 C2, which derives from the same applicant. The strength here is achieved, for very low weight, primarily via the plastic (PU) which penetrates into the region of the vertical fillets of the honeycombs and bonds with these.

The process of the invention provides that the production of the decorative composite 110 and of the structural composite 130 takes place separately. This can take place in two manufacturing lines arranged alongside one another, where the hardening times of the individual layers of the decorative composite 110 and of the structural composite 130 run in parallel and the total process time for production of the composite component 100 is therefore not increased in comparison with the prior art mentioned in the introduction, but instead is reduced. The production of the decorative composite 110 and/or of the structural composite 130 can also be carried out by completely different suppliers at completely different locations.

In the first step, as in FIG. 2, the decorative composite 110 with the coloring layer 112 downward, is placed in a first mold 210, or, as an alternative, produced in said first mold 210. The colorant layer 112 is preferably produced via spraying with a layer thickness of from 0.03 to 0.06 mm (S&R) or with a layer thickness of from 0.3 to 0.6 mm (Panadur) by the in-mold-coating process (IMC process) directly in the CSM mold, which in the example described is the lower mold 210.

The structural composite 130 is produced in a second step separately therefrom.

In the third step, as in FIG. 3, the connecting layer 120 is applied by means of an injection mold 250 provided with at least one nozzle 255, to the inner side of the backing layer 114.

In the fourth step, as in FIG. 4, the structural composite 130 has been secured on an upper mold 230 or, as an alternative to this, placed onto the connecting layer 120. When the upper mold 230 is compressed with the lower mold 210, the connecting layer 120 connects the structural composite 130 to the decorative composite 110, during the hardening process.

The finished composite component 100 forms by way of example a roof module or a vehicle door of a vehicle. However, the invention can also be advantageously realized on other vehicle components, such as wheel surrounds, engine-compartment lids, trunk lids, tailgate modules, roof shells of cabriolet covers, front spoilers or rear spoilers, and is also suitable for other plastics composite components which are not used in the motor-vehicle sector.

A composite component designed as vehicle-roof module is subject to greater pressure in the edge regions, within the mold. Here, the spacer 134 is omitted, and the resultant space is provided from below with a backing layer which increases the stability of the vehicle-roof module and which is preferably produced via injection molding in the long fiber injection-molding process (LFI-PUR process) from polyurethane into which fiber material has been injected. Once a composite component designed as the vehicle-roof module has been installed, the location of these increased-strength edge regions is in the flange regions of the roof frame at the level of the adhesive beads (in which connection see the application DE 10 2008 033 923.7, the priority date of which is earlier than that of the present application).

1. A process for producing a composite component, for a vehicle-exterior-skin, comprising the steps of:
1.1 separate producing of a decorative composite made of at least one backing layer and of at least one colorant layer,
1.2 separate producing of a structural composite made of at least one outer layer and of at least one spacer connected thereto, where step 1.2 takes place at a spatial distance from the location of the other steps,
1.3 introducing of a connecting layer between decorative composite and structural composite, and
1.4 joining of the structural composite and of the decorative composite together with hardening of the connecting layer.

2. The process as claimed in claim 1, characterized in that the backing layer of the decorative composite is composed of metal, such as aluminum or steel, or of thermoplastics or of thermosets.

3. The process as claimed in claim 1, characterized in that the colorant layer is composed of one or more of the following layers: a paint and/or a primer and/or a foil and/or a layer of material.

4. The process as claimed in claim 1, characterized in that the connecting layer is formed from a foaming or nonfoaming polymer.

5. The process as claimed in claim 1, characterized in that the spacer of the structural layer is composed of a paper honeycomb, of a polyurethane foam, of a polymer foam, of expanded polystyrene (EPS), of expanded polypropylene (EPP) or of expanded polycarbonate (EPC), of melamine, of a metal foam, of foamed aluminum, of a naturally occurring raw material, or of a monolytic structure, of sheet metal, of glassfiber-reinforced polyurethane (PU-GF), of glassfiber-reinforced epoxy (EP-GF), or of glassfiber-reinforced polycarbonate (PC-GF).

6. The process as claimed in claim 1, characterized in that the at least one outer layer of the structural layer has been formed from a fiber layer which is made of glass fiber, of glassfiber-reinforced polyurethane (PU-GF), of natural fibers, of polymer fibers, of inorganic fibers, of metallic fibers, or of carbon fibers and which has been embedded into a plastics matrix made of polyamide (PA), polypropylene (PP), epoxy (EP), or polyurethane (PU).

7. The process as claimed in claim 1, characterized in that two outer layers have been arranged on the two sides of the spacer.

8. The process as claimed in claim 1, characterized in that the at least one outer layer has been connected with an adhesive penetrating into cavities of the spacer or with a liquid plastic.

9. The process as claimed in claim 1, characterized in that at least one shatter proofing layer has been integrated into the decorative composite and/or into the structural composite.

10. The process as claimed in claim 1, characterized in that steps 1.1 and 1.3 take place in succession in a first mold.

11. The process as claimed in claim 1, characterized in that the intermediate product of step 1.2 is inserted into the second mold.

12. The process as claimed in any of claims 10 to 11, characterized in that step 1.4 takes place via compression of the first mold with the second mold.

13. A composite component produced as claimed in claim 1.

14. The composite component as claimed in claim 13, characterized in that the thickness of the connecting layer is in the range of about 2 mm to 2.5 mm.

15. The use of a composite component as claimed in claim 14 for a vehicle-exterior-skin component, selected from the group consisting of a vehicle-roof module, vehicle door, wheel surround, engine-compartment lid, trunk lid, tailgate module, roof shell of a cabriolet cover, front spoiler and rear spoiler.
